(19) United States
(12) Patent Application Publication
(10) Pub. No.: US 2007/0161362 A1
(43) Pub. Date: Jul. 12, 2007

(54) Apparatus and method for receiving signals transmitted over a distorting channel

(75) Inventor: Luigi Mattellini, Milano (IT)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/649,157

(22) Filed: Jan. 4, 2007

(30) Foreign Application Priority Data
Jan. 9, 2006 (EP) 06 000 293.8

(51) Int. Cl. H04B 1/10

(52) U.S. Cl. 455/307

(57) ABSTRACT

A receiver, in particular a digital receiver, for receiving signals transmitted over a distorting channel, comprising a prefilter for converting an impulse response of the channel into its equivalent minimum phase, a prefilter for use in such a receiver, and a method for receiving signals transmitting over a distorting channel in such a receiver, wherein the prefilter comprises a first filter stage including a plurality of symbol spaced matched filter and a second filter stage provided downstream the first filter stage and including a single whitening filter.

### FIELD OF THE INVENTION

The present invention relates to a receiver, in particular a digital receiver, for receiving signals transmitted over a distorting channel, comprising a prefilter for converting an impulse response of the channel into its equivalent minimum phase. Further, the present invention relates to such a prefilter for use in such a receiver. Finally, the present invention relates to a method for receiving signals transmitted over a distorting channel in a receiver, in particular a digital receiver, wherein an impulse response of the channel is converted into its equivalent minimum phase.

### BACKGROUND OF THE INVENTION

In a high-rate digital transmission over dispersive channels, the received signal is generally affected by intersymbol interference (ISI) and additive white Gaussian noise (AWGN). The channel distortion if left uncompensated causes high error rates. ISI compensation or reduction in a receiver is performed by an equalizer.

It is well known that the optimum equalization algorithm is given by maximum likelihood sequence detection (MLSD) as described in the article “Maximum-Likelihood Sequence Estimation of Digital Sequences in the Presence of Intersymbol Interference” by G. D. Forney, Jr., in IEEE Transactions on Information Theory, IT-18:363-378, 1972. However, for channels with large delay spread, i.e. long impulse response, or transmission using non-binary signal alphabets, the receiver requires a very complex structure, but usually sub-optimum schemes have to be considered for a practical implementation.

Potential measures include a decision feedback equalization (DFE) or a reduced-state sequence estimation (RSSE) as described by M. V. Eyuboglu and S. U. Qureshi in the article “Reduced-State Sequence Estimation with Set Partitioning and Decision Feedback” published in IEEE Trans. on Communications, COM-36:13-20, 1988. For any sub-optimum trellis based equalizer, a minimum phase discrete overall channel impulse response is essential for high performance. In general, the overall channel impulse response has a mixed phase, and the introduction of a discrete time prefilter in front of the equalizer is required which prefilter transforms the channel impulse response into its minimum phase equivalent.

As to the prior art, further reference is made to the following documents:
[1] Naofal Al-Dhahir and John M. Cioffi. “MMSE Decision-Feedback Equalizers: Finite-Length Results”. IEEE Transactions on Information Theory, vol. 41, No. 4, pp. 961-975, July 1995,
[2] Naofal Al-Dhahir and John M. Cioffi. “Fast Computation of Channel-Estimate Based Equalizers in Packet Data Transmission”. IEEE Transactions on Signal Processing, vol. 43, No. 11, pp. 3462-3473, November 1995,
[3] WO 01/95509 A1,
[4] EP 1 032 170 A1.

In document [1] it is shown a method to derive minimum mean square error (MMSE) prefilter coefficients while in document [2] it is shown how to derive the same coefficients as in document [1] but with a noticeable saving in processing power.

According to the teaching of document [3] the oversampled streams have been grouped together in a different order. The method of document [3] has its main advantage when the fast Cholesky method as described in document [2] is carried out, and that further the processing power needed to obtain the MMSE pre-filter coefficients is reduced.

According to the teachings of the documents [1] to [3], the feedforward and feedback coefficients of a DFE are determined under the MMSE criterion.

Document [4], representing the closest prior art from which the invention proceeds, discloses an apparatus and a method for receiving signals transmitted over a distorted channel but using a first filter stage including one matched filter and a second filter stage. So, this document deals with the case of a single antenna receiver.

A possible implementation of the solution proposed in document [1] is shown in FIG. 1, wherein the signal input to a feedforward filter W(z) is obtained by multiplexing together two (or more) signals from different antennas. In case of a single antenna receiver, a single oversampled signal would have been obtained. The feedforward filter W(z) is operating in the fractionally spaced domain. Its output is then down sampled in order to produce a symbol spaced signal.

In the following the case of the provision of a symbol spaced equalizer will be considered, wherein NSPS is the number of samples per symbol.

For sake of simplicity the case of NSPS=2 will be taken into account only. However, of course the extension to different oversampling factors is straightforward. An oversampling factor of 2 can be obtained, for instance, from a dual antenna receiver as shown in FIG. 1 where each antenna provides a symbol spaced stream or from a single antenna receiver where two samples per symbol are provided. The received signal can be written as

y=Hx+n (1)

where the following definitions apply

$${y}_{k} ≡ [ \begin{matrix}{y}_{1} [ k ] \\ {y}_{2} [ k ]\end{matrix} ] ; {h}_{k} ≡ [ \begin{matrix}{h}_{1} [ k ] \\ {h}_{2} [ k ]\end{matrix} ] ; {n}_{k} ≡ [ \begin{matrix}{n}_{1} [ k ] \\ {n}_{2} [ k ]\end{matrix} ] ; ( intra symbol ) \\ {H}_{( 2 \times Nf . Nf + L - 1 )} ≡ [ \begin{matrix}{h}_{0} & ⋯ & {h}_{L - 1} & 0 & ⋯ & 0 \\ 0 & {h}_{0} & ⋯ & {h}_{L - 1} & ⋯ & 0 \\ ⋮ & & ⋱ & & ⋱ & \\ 0 & ⋯ & 0 & {h}_{0} & ⋯ & {h}_{L - 1}\end{matrix} ] ; \\ {y}_{( 2 \times Nf .1 )} ≡ [ \begin{matrix}{y}_{K + Nf - 1} \\ ⋮ \\ {y}_{K + 1} \\ {y}_{K}\end{matrix} ] ; {n}_{( 2 \times Nf .1 )} ≡ [ \begin{matrix}{n}_{K + Nf - 1} \\ ⋮ \\ {n}_{K + 1} \\ {n}_{K}\end{matrix} ] ; \\ {x}_{( Nf + L - 1.1 )} ≡ [ \begin{matrix}x [ K + Nf - 1 ] \\ x [ K + Nf - 2 ] \\ ⋮ \\ x [ K - L + 1 ]\end{matrix} ] \qquad ( 2 )$$

and H is the convolution channel matrix, x are training samples and n is the noise, subscripts “1” and “2” refer to odd and even samples in a symbol, L is the channel length, and Nf is the feedforward filter length.

Under the MMSE criterion the feedforward (w) and feedback (b) filter coefficients are given by:

$$\begin{matrix}\{ \begin{matrix} {w}^{*} = \tilde{h} * {( {HH}^{*} + {σ}_{n}^{2} I - {HS}^{T} {SH}^{*} )}^{- 1} \\ {b}^{*} = W * {HS}^{T}\end{matrix} \\ where & ( 3 ) \\ {\tilde{h}}_{( 1 , Nf )}^{*} ≡ [ \underbrace{0 … 0}_{Nf - L} \underbrace{{h}_{L - 1}^{*} … {h}_{0}^{*}}_{L} ] , {σ}_{n}^{2} {I}_{( Nf , Nf )} = E [ {nn}^{*} ] and \\ {S}_{( L - 1 , Nf + L - 1 )} [ \begin{matrix}0 & ⋯ & 0 & 1 & & \\ ⋮ & & ⋮ & & ⋰ & \\ 0 & ⋯ & 0 & & & 1\end{matrix} ] = [ {0}_{( L - 1 , Nf )} \vert {I}_{( L - 1 , L - 1 )} ] & ( 4 )\end{matrix}$$

The receiver structure according to document [3] is shown in FIG. 2 where the case of a single antenna receiver providing two samples per symbol is considered (however, the extension to a multi antenna receiver or to different over sampling factor is straightforward). In this case a bank of two feedforward filters W₁(z) and W₂(z) connected in parallel to the output of a demultiplexer DeMux is provided. Each filter W₁(z), W₂(z) is processing a symbol spaced sub-stream of the received signal. The filter coefficients under the MMSE criterion are given by equation (3) where now the following definitions apply:

$$\begin{matrix}{y}_{( 2 Nf .1 )} ≡ [ \frac{{y}_{1} ( K + Nf - 1 \text{:} K )}{{y}_{2} ( K + Nf - 1 \text{:} K )} ] ; \\ {H}_{( 2 Nf . Nf + L - 1 )} ≡ [ \frac{{H}_{1}}{{H}_{2}} ] \\ {x}_{( Nf + L - 1 , 1 )} ≡ [ \begin{matrix}x [ K + Nf - 1 ] \\ x [ K + Nf - 2 ] \\ ⋮ \\ x [ K - L + 1 ]\end{matrix} ] ; \\ {n}_{( 2 Nf .1 )} ≡ [ \frac{{n}_{1} ( K + Nf - 1 \text{:} K )}{{n}_{2} ( K + Nf - 1 \text{:} K )} ] and & ( 5 ) \\ {y}_{i} ( K + Nf - 1 \text{:} K ) ≡ [ \begin{matrix}{y}_{i} [ K + Nf - 1 ] \\ {y}_{i} [ K + Nf - 2 ] \\ ⋮ \\ {y}_{i} [ K ]\end{matrix} ] ; \\ {n}_{i} ( K + Nf - 1 \text{:} K ) ≡ [ \begin{matrix}{n}_{i} [ K + Nf - 1 ] \\ {n}_{i} [ K + Nf - 2 ] \\ ⋮ \\ {n}_{i} [ K ]\end{matrix} ] \\ {H}_{i} ≡ [ \begin{matrix}{h}_{i} [ 0 ] & ⋯ & {h}_{i} [ L - 1 ] & 0 & ⋯ & 0 \\ 0 & {h}_{i} [ 0 ] & ⋯ & {h}_{i} [ L - 1 ] & ⋯ & 0 \\ ⋮ & & ⋰ & & ⋰ & \\ 0 & ⋯ & 0 & {h}_{i} [ 0 ] & ⋯ & {h}_{i} [ L - 1 ]\end{matrix} ] & ( 6 )\end{matrix}$$

### As it becomes clear from the above, the structures required by the calculation result in a rather complex construction for the receiver.

A time discrete symbol spaced receiver structure as described in document [4] is shown in FIG. 3. This receiver structure comprises a linear prediction (LP) based prefilter PF including a first filter stage and a second filter stage arranged downstream the first filter stage. The first filter stage comprises a matched filter MF, and the second stage comprises a single whitening filter W.

After the matched filter MF, in order to convert the impulse response of the channel so as to obtain a minimum phase, in the whitening filter W all the zeros have to be deleted out of the unit circle in the Z domain. Ideally an all-poles filter can perform this operation. Practically, even knowing the pole positions (roots), which is a rather demanding process in terms of computations required, due to noise and round off errors, the IIR (infinite impulse response) whitening filter might be not stable. Therefore, the all-poles IIR filter is preferably approximated by providing an all-zeros FIR filter, and as FIR filter a backward linear predictor is preferably selected, given that the impulse response of a backward linear prediction filter is maximum phase (minimum phase for a forward linear predictor).

After the MF in the whitening filter W it is obtained

H(z)H*(1/z*)=Hₘᵢₙ(z)H*ₘᵢₙ*(1/z*), (7)

where Hₘᵢₙ(z) is the transfer function of the minimum phase channel impulse response in the Z domain and H(z) is the transfer function of the channel impulse response which will be in general a mixed phase (with roots inside and outside the unit circle in the Z domain).

So, it is wanted to provide a filtering function W(z) satisfying the condition

H(z)H*(1/z*)W(z)=Hₘᵢₙ(z) (8)

and therefore, by combining equations (7) and (8), it is obtained

Hₘᵢₙ(z)H*ₘᵢₙ₍1/z*)W(z)=Hₘᵢₙ(z)= [symbol] W(z)=1/H*ₘᵢₙ(1/z*) (9)

### The provision of a filter W having a function W(z) as expressed by equation (9) is equivalent to the provision of a filter G(z) as follows

W(z)=1/H*ₘᵢₙ(1/z*) [symbol] G(z)=1/Hₘᵢₙ(1/z) (10)

As for the MF, in the time domain, equation (10) is equivalent to g[k]=w[−k]; i.e. filter g is the complex-conjugated time reversed version of w. Instead of estimating an anti-causal filter w, it is to be looked for a causal version g. The filter G(z) is imposed to be a forward linear predictor

$$G ( z ) = 1 - {\sum }_{i = 1}^{Nf - 1} g [ i ] {z}^{- i} \qquad ( 11 )$$

### As for every linear predictor (auto regressive modeling) if it is defined

rₕₕ[k]=h[k]\hat{×}h*[−k] (12)

the Yule-Walker equations can be written as

$$[ \begin{matrix}{r}_{hh} [ 0 ] & {r}_{hh} [ - 1 ] & ⋯ & {r}_{hh} [ - Nf + 2 ] \\ {r}_{hh} [ 1 ] & {r}_{hh} [ 0 ] & ⋯ & {r}_{hh} [ - Nf + 3 ] \\ ⋮ & ⋮ & ⋰ & ⋮ \\ {r}_{hh} [ Nf - 2 ] & {r}_{hh} [ Nf - 3 ] & ⋯ & {r}_{hh} [ 0 ]\end{matrix} ] [ \begin{matrix}g [ 1 ] \\ g [ 2 ] \\ ⋮ \\ g [ Nf - 1 ]\end{matrix} ] = [ \begin{matrix}{r}_{hh} [ 1 ] \\ {r}_{hh} [ 2 ] \\ ⋮ \\ {r}_{hh} [ Nf - 1 ]\end{matrix} ] \qquad ( 13 )$$

### Solving the system in equation (13) gives the whitening filter coefficients.

It should be noted that Nf-1 coefficients are now estimated because the first coefficient is already known to be 1. So, the whitening filter will have therefore Nf coefficients.

The output signal from the prefilter PF, which output signal is the output signal of the whitening filter W, is input into an equalizer E which operates as a distortion corrector.

Instead of using a single filter stage for converting the channel impulse response into its equivalent minimum phase as it is done by a MMSE-DFE receiver according to the documents [1] to [3], document [4] teaches to perform this operation in two steps by providing a first filter stage and a second filter stage. The first filter stage includes one matched filter, whereas the second filter stage provided downstream the first filter stage includes a single whitening filter.

### SUMMARY OF THE INVENTION

It is an object of the invention to provide an apparatus and a method which allow the use of more than one sample per symbol in a single antenna receiver where the received signal is oversampled or in a multi antenna receiver where the different signals from each antenna can be oversampled or not.

In order to achieve the above and further objects, in accordance with a first aspect of the present invention, there is provided a receiver, in particular a digital receiver, for receiving signals transmitted over a distorting channel, comprising a prefilter for converting an impulse response of the channel into its equivalent minimum phase, and a distortion corrector provided downstream said prefilter, wherein said prefilter comprises a first filter stage including a matched filter and a second filter stage provided downstream said first filter stage and including a single whitening filter, wherein said prefilter is a fractionally spaced filter, said prefilter further comprises a decomposer for decomposing a fractionally spaced stream into a plurality of symbol spaced sub-streams, the number of said plurality of symbol spaced sub-streams being at least equal to the number of samples per symbol, wherein said first filter stage includes a plurality of symbol spaced matched filters connected in parallel to the output of said decomposer, the number of said plurality of symbol spaced matched filters being at least equal to the number of symbol spaced sub-streams, and said prefilter further comprises an adder for summing the output signals of said plurality of symbol spaced matched filters so as to produce a single symbol spaced stream input into said whitening filter.

In accordance with a second aspect of the present invention, there is provided a receiver, in particular a digital receiver, for receiving signals transmitted over a distorting channel, comprising a prefilter for converting an impulse response of the channel into its equivalent minimum phase, and a distortion corrector provided downstream said prefilter, wherein said prefilter comprises a first filter stage including a matched filter and a second filter stage provided downstream said first filter stage and including a single whitening filter, wherein said prefilter is a fractionally spaced filter, the receiver further comprises a plurality of antennas and a multiplexer for multiplexing oversampled streams arising from said plurality of antennas so as to form a single stream having an oversampling factor being at least equal to the number of samples per symbol multiplied by the number of antennas, said prefilter further comprises a decomposer for decomposing a fractionally spaced stream into a plurality symbol spaced sub-streams, the number of said plurality of symbol spaced sub-streams being at least equal to the number of samples per symbol multiplied by the number of antennas, the input of said decomposer being coupled to the output of said multiplexer, wherein said first filter stage includes a plurality of symbol spaced matched filters connected in parallel to the output of said decomposing means, the number of said plurality of symbol spaced matched filters being at least equal to the number of samples per symbol multiplied by the number of antennas, and said prefilter further comprises an adder for summing the output signals of said plurality of symbol spaced matched filters so as to produce a single symbol spaced stream input into said whitening filter.

In accordance with a third aspect of the present invention, there is provided a prefilter for use in a receiver, in particular a digital receiver, the receiver being adapted to receive signals transmitted over a distorting channel and comprising the prefilter for converting an impulse response of the channel into its equivalent minimum phase and a distortion corrector provided downstream said prefilter, wherein said prefilter comprises a first filter stage including a matched filter and a second filter stage provided downstream said first filter stage and including a single whitening filter, wherein the prefilter is a fractionally spaced filter, and further comprises a decomposer for decomposing a fractionally spaced stream into a plurality of symbol spaced sub-streams, the number of said plurality of symbol spaced sub-streams being at least equal to the number of samples per symbol, wherein said first filter stage includes a plurality of symbol spaced matched filters connected in parallel to the output of said decomposer, the number of said plurality of symbol spaced matched filters being at least equal to the number of symbol spaced sub-streams, and an adder for summing the output signals of said plurality of symbol spaced matched filters so as to produce a single symbol spaced stream input into said whitening filter.

In accordance with a fourth aspect of the present invention, there is provided a prefilter for use in a receiver, in particular a digital receiver, the receiver being adapted to receive signals transmitted over a distorting channel and comprising the prefilter for converting an impulse response of the channel into its equivalent minimum phase and a distortion corrector provided downstream said prefilter, wherein said prefilter comprises a first filter stage including a matched filter and a second filter stage provided downstream said first filter stage and including a single whitening filter, wherein the prefilter is a fractionally spaced filter, the receiver comprises a plurality of antennas and a multiplexer for multiplexing oversampled streams arising from said plurality of antennas so as to form a single stream having an oversampling factor being at least equal to the number of samples per symbol multiplied by the number of antennas, and further comprises a decomposer for decomposing a fractionally spaced stream into a plurality symbol spaced sub-streams, the number of said plurality of symbol spaced sub-streams being at least equal to the number of samples per symbol multiplied by the number of antennas, the input of said decomposer being coupled to the output of said multiplexer, wherein said first filter stage includes a plurality of symbol spaced matched filters connected in parallel to the output of said decomposer, the number of said plurality of symbol spaced matched filters being at least equal to the number of samples per symbol multiplied by the number of antennas, and an adder for summing the output signals of said plurality of symbol spaced matched filters so as to produce a single symbol spaced stream input into said whitening filter.

In accordance with a fifth aspect of the present invention, there is provided a method for receiving signals transmitted over a distorting channel in a receiver, in particular a digital receiver, comprising the steps of filtering the signals in a first filter stage including a matched filter, filtering the output signals of said first filter stage in a second filter stage including a single whitening filter, said first and second filter stages defining a prefilter for converting an impulse response of the channel into its equivalent minimum phase, and correcting a distortion in the output signals of said second filter stage in a distortion corrector, comprising the further steps of providing said prefilter as a fractionally spaced filter, decomposing a fractionally spaced stream into a plurality of symbol spaced sub-streams, the number of said plurality of symbol spaced sub-streams being at least equal to the number of samples per symbol, filtering each symbol spaced sub-stream in a symbol spaced matched filter of a plurality of symbol spaced matched filters included in said first filter stage and connected in parallel, the number of said plurality of symbol spaced matched filters being at least equal to the number of symbol spaced sub-streams, summing the output signals of said plurality of symbol spaced matched filters so as to produce a single symbol spaced stream, and inputting said single symbol spaced stream into the whitening filter of said second filter stage.

In accordance with a sixth aspect of the present invention, there is provided a method for receiving signals transmitted over a distorting channel in a receiver, in particular a digital receiver, comprising the steps of filtering the signals in a first filter stage including a matched filter, filtering the output signals of said first filter stage in a second filter stage including a single whitening filter, said first and second filter stages defining a prefilter for converting an impulse response of the channel into its equivalent minimum phase, and correcting a distortion in the output signals of said second filter stage in a distortion corrector, comprising the further steps of providing said prefilter as a fractionally spaced filter, receiving the signals via a plurality of antennas, multiplexing oversampled streams arising from said plurality of antennas so as to form a single stream having an oversampling factor being at least equal to the number of samples per symbol multiplied by the number of antennas, decomposing a fractionally spaced stream into a plurality of symbol spaced sub-streams being at least equal to the number of sample per symbol multiplied by the number of antennas, filtering each symbol spaced sub-stream in a symbol spaced matched filter of a plurality of symbol spaced matched filters included in said first filter stage and connected in parallel, the number of said plurality of symbol spaced matched filters being at least equal to the number of samples per symbol multiplied by the number of antennas, summing the output signals of said plurality of symbol spaced matched filters so as to produce a single symbol spaced stream, and inputting said single symbol spaced stream into the whitening filter of said second filter stage.

In accordance with a seventh aspect of the present invention, there is provided a mobile unit, in particular a radio telephone, comprising a receiver in accordance with the first aspect.

Further advantageous embodiments of the present invention are defined in the dependent claims.

The present invention is focused onto receivers operating with a sample rate bigger than one sample per symbol, i.e. making use of more than one sample per symbol, and/or equipped with more than one antenna. Exactly the same algorithms can be used in receivers equipped with one or more than one antenna, and the streams from a different antenna can be viewed as additional oversampling dimensions. The present invention preferably requires a less number of complex operations for oversampling factors higher than or equal to 4, or two antennas with oversampling factors of 2, and feedforward filter lengths bigger than seven samples. If the oversampling factor is 2, the present invention will preferably be advantageous for feedforward filter orders higher than 8. Further, the distortion corrector can be provided as an equalizer which can be symbol spaced or fractionally spaced.

An advantage of the present invention, compared to prior art solutions, is in the reduced complexity of the receiver structure for processing high oversampling rates, where the prefilter can easily become a bottleneck of the overall receiver structure in terms of operations required, which is substantially overcome by the teaching of the present invention.

EP 1 032 170 A1 discloses an apparatus and a method for receiving signals transmitted over a distorted channel by using a first filter stage including one matched filter and a second filter stage. However, this prior art only deals with the case of a single antenna receiver, but does not give any hint at how to apply the apparatus and method disclosed therein to receivers operating with a sample rate bigger than one sample per symbol and/or receivers equipped with more than one antenna and therefore does not propose a particular implementation in such receivers as taught by the present invention. Further, this prior art does not suggest the provision of a plurality of matched filters in the first filter stage with each matched filter filtering a symbol spaced sub-stream. Finally, this prior art does not teach to provide the second filter stage with a single whitening filter function. So, this prior art neither anticipates the present invention nor renders it obvious.

The apparatus and the method according to the present invention can be applied to several technologies. Preferably, the apparatus according to the present invention refers to a digital receiver in the GSM/EDGE system, but is not restricted thereto. Moreover, the present invention can be applied to every high rate digital transmission over dispersive channels. Finally, the present invention can be implemented in a mobile unit, in particular a radio telephone, of a mobile telecommunication system.

A more complete appreciation of the present invention and the scope thereof can be obtained from the accompanying drawings which are briefly summarized below, the following detailed description of the presently preferred embodiments of the invention, and to the appended claims.

### BRIEF DESCRIPTION OF THE DRAWINGS

FIG. 1 shows a schematic block diagram of a prior art MMSE-DFE receiver structure as described in document [1];

FIG. 2 shows a schematic block diagram of another prior art MMSE-DFE receiver structure as described in document [3];

FIG. 3 shows a schematic block diagram of still another prior art receiver structure including a linear prediction based prefilter for a single antenna receiver as described in document [4];

FIG. 4 shows a schematic block diagram of a single antenna receiver structure with a fractionally spaced implementation of a linear prediction prefilter according to a first preferred embodiment of the present invention; and

FIG. 5 shows a schematic block diagram of a multi-antenna receiver structure with a fractionally spaced implementation of a linear prediction prefilter according to a second preferred embodiment of the present invention.

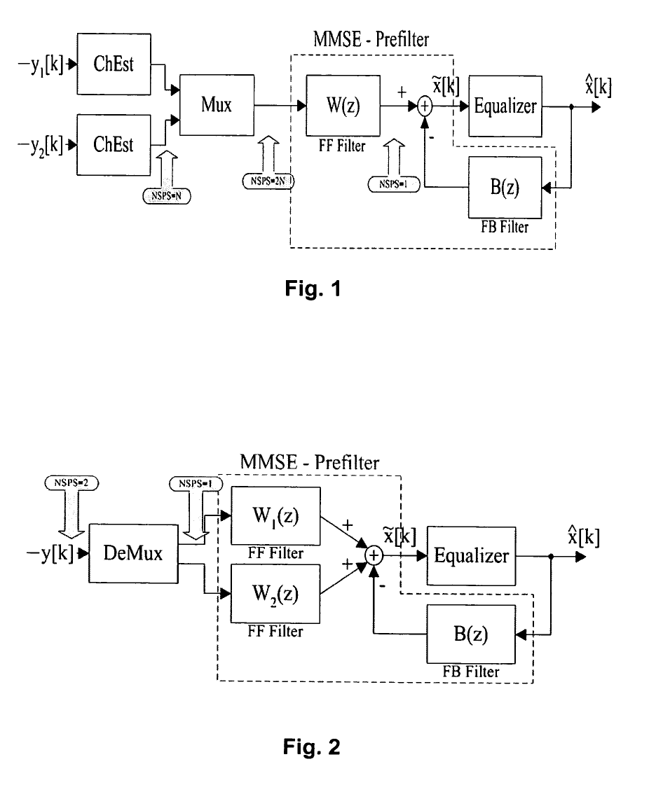

### DESCRIPTION OF THE PREFERRED EMBODIMENTS

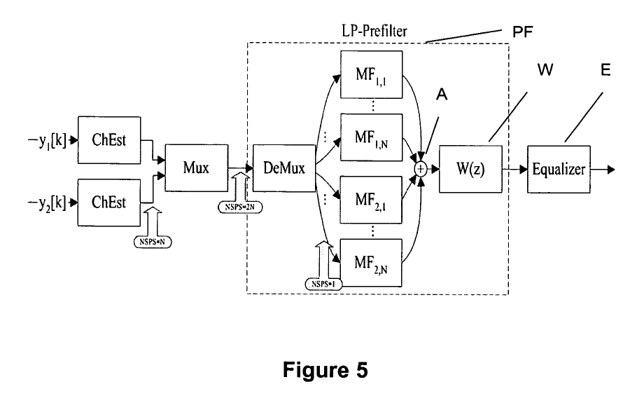

In the following, preferred embodiments of the present invention will be described with reference to FIGS. 4 and 5. With respect thereto, it should be noted that, as far as the equations (1) to (13) and the associated descriptions as given above apply to the preferred embodiments, they are not repeated in the following description.

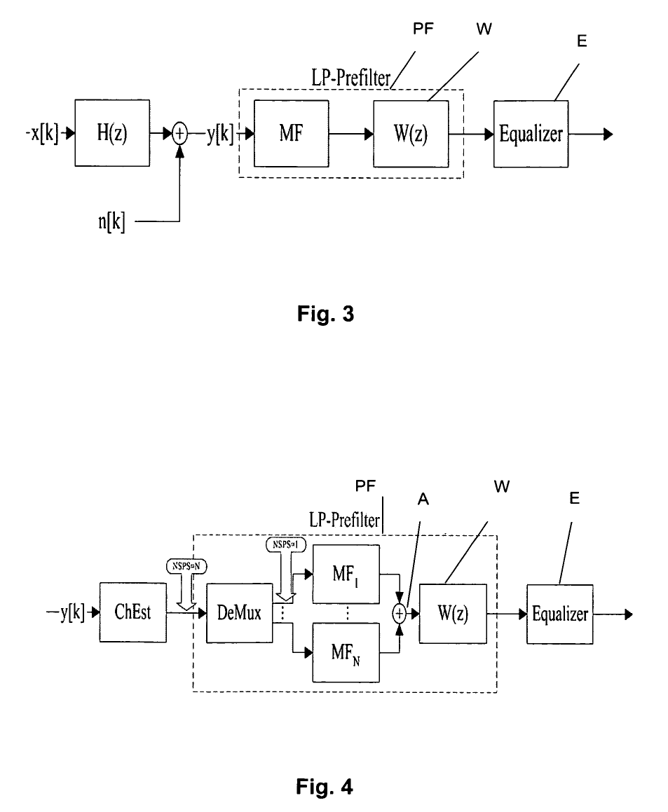

FIG. 4 shows a schematic block diagram of a single antenna receiver structure which is similar to that of FIG. 3, but differs therefrom in a fractionally spaced implementation of the LP prefilter according to a first preferred embodiment of the present invention. In order to avoid a repetition here, reference is made to the above description of FIG. 3 for the elements of FIG. 4 which are identical to those of FIG. 3.

Concretely, the receiver structure of FIG. 4 differs from that of FIG. 3 in that the first filter stage comprises not only one matched filter, but a plurality of symbol spaced matched filters MF₁ to MF_{N}, and further a demultiplexer DeMux and an adder A are additionally provided. The received fractionally spaced stream is decomposed into a plurality of symbol spaced sub-streams by the demultiplexer DeMux. The number of the plurality of symbol spaced sub-streams output from the demultiplexer DeMux is equal to NSPS (number of samples per symbol), and likewise the number of the plurality of symbol spaced matched filters MF₁ to MF_{N} is equal to NSPS. Each sub-stream is filtered by an associated symbol spaced matched filter MF₁ . . . MF_{N} with N=NSPS. The NSPS sub-streams output from the plurality of symbol spaced matched filters MF₁ to MF_{N} are then added from the adder to a single symbol spaced stream which is output from the adder A and input into the whitening filter W, and the filtering function W(z) of the single whitening filter W is calculated and applied.

The same criterion can be applied for a multi antenna receiver. As an example, according to a second preferred embodiment of the present invention, FIG. 5 shows an embodiment of a two antennas receiver structure which differs from the single antenna embodiment of FIG. 4 in that the number of the plurality of symbol spaced matched filters MF_{1.1} to MF_{1.N} and MF_{2.1} to MF_{2.N} is twice the number of the plurality of symbol matched filters of the embodiment of FIG. 4 and that a multiplexer Mux is additionally provided. The oversampled streams arising from the two antennas are multiplexed together by the multiplexer Mux so to form a single stream which is output from the multiplexer Mux and input into the demultiplexer DeMux and has an oversampling factor equal to NSPS×2, i.e. twice NSPS. The number of the plurality of symbol spaced matched filters MF_{1.1} to MF_{1.N} and MF_{2.1} to MF_{2.N} is equal to NSPS×2, too. So, according to this stream a matched filter MF_{1.1} . . . MF_{1.N}, MF_{2.1} . . . MF_{2.N} is provided for every single symbol spaced stream. The outputs from the matched filters MF_{1.1} to MF_{1.N} and MF_{2.1} to MF_{2.N} are added by the adder to a single symbol spaced stream which is output from the adder and input into the single whitening filter W, and the filtering function W(z) of the single whitening filter W is calculated and applied.

It should be noted that the latter embodiment described above and shown in FIG. 5 is not restricted to the provision of two antennas, but can of course be applied to any multi antenna receiver structure, wherein the oversampling factor is equal to NSPS multiplied by the number of antennas provided, and likewise the number of the plurality of symbol spaced matched filters is equal to NSPS multiplied by the number of antennas provided.

The equalizer E can be symbol spaced or fractionally spaced, wherein in the above described preferred embodiments the provision of a symbol spaced equalizer is preferred.

Finally, it should be noted that the above preferred descriptions are of preferred examples for implementing the present invention, but the scope of the present invention should not necessarily be limited by this description. The scope of the present invention is defined by the following claims.

1. A receiver, comprising:
a prefilter configured to convert an impulse response of a channel into an equivalent minimum phase of the impulse response, wherein the receiver is configured to receive signals transmitted over the channel and the channel is a distorting channel; and
a distortion corrector provided downstream from said prefilter,
wherein said prefilter comprises a first filter stage including a matched filter and a second filter stage provided downstream from said first filter stage and including a single whitening filter,
wherein said prefilter is configured to be a fractionally spaced filter,
wherein said prefilter further comprises a decomposer configured to decompose a fractionally spaced stream into a plurality of symbol spaced sub-streams, the number of said plurality of symbol spaced sub-streams being at least equal to the number of samples per symbol,
wherein said first filter stage includes a plurality of symbol spaced matched filters connected in parallel to the output of said decomposer, the number of said plurality of symbol spaced matched filters being at least equal to the number of symbol spaced sub-streams, and
wherein said prefilter further comprises an adder configured to sum the output signals of said plurality of symbol spaced matched filters so as to produce a single symbol spaced stream input into said whitening filter.

2. The receiver according to claim 1, wherein said decomposer comprises a demultiplexer.

3. The receiver according to claim 1, further comprising:
at least one sampler configured to produce sample signals from the received signal, wherein said at least one sampler is provided upstream from said prefilter and is configured to produce more than one sample per symbol.

4. The receiver according to claim 1, wherein said distortion corrector is an equalizer.

5. The receiver according to claim 1, wherein said distortion corrector is a symbol spaced corrector.

6. The receiver according to claim 1, wherein said distortion corrector is a fractionally spaced corrector.

7. The receiver according to claim 1, wherein said prefilter is a linear prediction-based prefilter.

8. The receiver according to claim 1, wherein said whitening filter comprises an all-poles filter.

9. The receiver according to claim 8, wherein the all-poles filter comprises an all-poles infinite impulse response filter.

10. The receiver according to claim 8, wherein the all-poles filter comprises an all-zeros finite impulse response filter.

11. The receiver according to claim 10, wherein the all-zeros finite impulse response filter comprises a backward linear prediction filter.

12. A receiver, comprising:
a prefilter configured to convert an impulse response of the channel into an equivalent minimum phase of the impulse response, wherein the receiver is configured to receive signals transmitted over the channel and the channel is a distorting channel;
a distortion corrector provided downstream from said prefilter, wherein said prefilter comprises a first filter stage including a matched filter and a second filter stage provided downstream from said first filter stage and including a single whitening filter, wherein said prefilter is configured to be a fractionally spaced filter;
a plurality of antennas; and
a multiplexer configured to multiplex oversampled streams arising from said plurality of antennas so as to form a single stream having an oversampling factor that is at least equal to the number of samples per symbol multiplied by the number of antennas,
wherein said prefilter further comprises a decomposer configured to decompose a fractionally spaced stream into a plurality symbol spaced sub-streams, the number of said plurality of symbol spaced sub-streams being at least equal to the number of samples per symbol multiplied by the number of antennas,
wherein the input of said decomposer is coupled to the output of said multiplexer,
wherein said first filter stage includes a plurality of symbol spaced matched filters connected in parallel to the output of said decomposer, the number of said plurality of symbol spaced matched filters being at least equal to the number of samples per symbol multiplied by the number of antennas, and
wherein said prefilter further comprises an adder configured to sum the output signals of said plurality of symbol spaced matched filters so as to produce a single symbol spaced stream input into said whitening filter.

13. The receiver according to claim 12, wherein said decomposer comprises a demultiplexer.

14. The receiver according to claim 12, further comprising:
at least one sampler configured to produce sample signals from the received signal, wherein said at least one sampler is provided upstream from said prefilter and is configured to produce more than one sample per symbol.

15. The receiver according to claim 12, wherein said distortion corrector is an equalizer.

16. The receiver according to claim 12, wherein said distortion corrector is a symbol spaced corrector.

17. The receiver according to claim 12, wherein said distortion corrector is a fractionally spaced corrector.

18. The receiver according to claim 12, wherein said prefilter is a linear prediction-based prefilter.

19. The receiver according to claim 12, wherein said whitening filter comprises an all-poles filter.

20. The receiver according to claim 19, wherein said all-poles filter comprises an all-poles infinite impulse response filter.

21. The receiver according to claim 19, wherein the all-poles filter comprises an all-zeros finite impulse response filter.

22. The receiver according to claim 21, wherein the all-zeros finite impulse response filter comprises a backward linear prediction filter.

23. A prefilter, comprising:
a first filter stage including a matched filter;
a second filter stage provided downstream from said first filter stage and including a single whitening filter, wherein the prefilter is a fractionally spaced filter; and
a decomposer configured to decompose a fractionally spaced stream into a plurality of symbol spaced sub-streams, the number of said plurality of symbol spaced sub-streams being at least equal to the number of samples per symbol,
wherein said first filter stage includes
a plurality of symbol spaced matched filters connected in parallel to the output of said decomposer, the number of said plurality of symbol spaced matched filters being at least equal to the number of symbol spaced sub-streams, and
an adder configured to sum the output signals of said plurality of symbol spaced matched filters so as to produce a single symbol spaced stream input into said whitening filter,
wherein the prefilter is configured to be used in a receiver, which is configured to receive signals transmitted over a distorting channel, and which comprises a distortion corrector provided downstream from said prefilter, and
wherein said prefilter is configured to convert an impulse response of the channel into an equivalent minimum phase of the impulse response.

24. The prefilter according to claim 23, wherein said decomposer comprises a demultiplexer.

25. The prefilter according to claim 23, wherein the prefilter is configured to be a linear prediction-based prefilter.

26. The prefilter according to claim 23, wherein said whitening filter comprises an all-poles filter.

27. The prefilter according to claim 26, wherein said all-poles filter comprises an all-poles infinite impulse response filter.

28. The prefilter according to claim 26, wherein the all-poles filter comprises an all-zeros finite impulse response filter.

29. The prefilter according to claim 28, wherein the all-zeros finite impulse response filter comprises a backward linear prediction filter.

30. A prefilter, comprising:
a first filter stage including a matched filter, wherein the prefilter is configured to be used in a receiver, which is configured to receive signals transmitted over a distorting channel, and which comprises a distortion corrector provided downstream from said prefilter; and
a second filter stage provided downstream from said first filter stage and including a single whitening filter, wherein the prefilter is a fractionally spaced filter, and wherein the receiver comprises a plurality of antennas and a multiplexer for multiplexing oversampled streams arising from said plurality of antennas so as to form a single stream having an oversampling factor being at least equal to the number of samples per symbol multiplied by the number of antennas; and
a decomposer configured to decompose a fractionally spaced stream into a plurality symbol spaced sub-streams, the number of said plurality of symbol spaced sub-streams being at least equal to the number of samples per symbol multiplied by the number of antennas,
wherein the input of said decomposer is coupled to the output of said multiplexer,
wherein said first filter stage includes
a plurality of symbol spaced matched filters connected in parallel to the output of said decomposer, the number of said plurality of symbol spaced matched filters being at least equal to the number of samples per symbol multiplied by the number of antennas, and
an adder configured to sum the output signals of said plurality of symbol spaced matched filters so as to produce a single symbol spaced stream input into said whitening filter,
wherein said prefilter is configured to convert an impulse response of the channel into an equivalent minimum phase of the impulse response.

31. The prefilter according to claim 30, wherein said decomposer comprises a demultiplexer.

32. The prefilter according to claim 30, wherein the prefilter is configured to be a linear prediction-based prefilter.

33. The prefilter according to claim 30, wherein said whitening filter comprises an all-poles filter.

34. The prefilter according to claim 33, wherein said all-poles filter comprises an all-poles infinite impulse response filter.

35. The prefilter according to claim 33, wherein said all-poles filter comprises an all-zeros finite impulse response filter.

36. The prefilter according to claim 35, wherein the all-zeros finite impulse response filter comprises a backward linear prediction filter.

37. A method, comprising:
receiving signals transmitted over a distorting channel in a receiver;
filtering the signals in a first filter stage including a matched filter;
filtering output signals of said first filter stage in a second filter stage including a single whitening filter, wherein said first and second filter stages define a prefilter for converting an impulse response of the channel into an equivalent minimum phase of the impulse response;
correcting a distortion in output signals of said second filter stage in a distortion corrector;
configuring said prefilter to be a fractionally spaced filter;
decomposing a fractionally spaced stream into a plurality of symbol spaced sub-streams, the number of said plurality of symbol spaced sub-streams being at least equal to the number of samples per symbol;
filtering each symbol spaced sub-stream in a symbol spaced matched filter of a plurality of symbol spaced matched filters included in said first filter stage and connected in parallel, the number of said plurality of symbol spaced matched filters being at least equal to the number of symbol spaced sub-streams;
summing the output signals of said plurality of symbol spaced matched filters so as to produce a single symbol spaced stream; and
inputting said single symbol spaced stream into the whitening filter of said second filter stage.

38. The method according to claim 37, wherein the whitening filtering is carried out as an all-poles filtering in said second filter stage.

39. The method according to claim 38, wherein the all-poles filtering is carried out as an all-poles infinitive impulse response filtering.

40. The method according to claim 38, wherein the all-poles filtering is carried out as an all-zeros finite impulse response filtering.

41. The method according to claim 40, wherein the all-zeros finite impulse response filtering is carried out as a backward linear prediction.

42. A method, comprising:
receiving signals transmitted over a distorting channel in a receiver;
filtering the signals in a first filter stage including a matched filter;
filtering output signals of said first filter stage in a second filter stage including a single whitening filter, wherein said first and second filter stages define a prefilter for converting an impulse response of the channel into an equivalent minimum phase of the impulse response;
correcting a distortion in the output signals of said second filter stage in a distortion corrector;
configuring said prefilter to be a fractionally spaced filter;
receiving the signals via a plurality of antennas;
multiplexing oversampled streams arising from said plurality of antennas so as to form a single stream having an oversampling factor being at least equal to the number of samples per symbol multiplied by the number of antennas;
decomposing a fractionally spaced stream into a plurality of symbol spaced sub-streams being at least equal to the number of sample per symbol multiplied by the number of antennas;
filtering each symbol spaced sub-stream in a symbol spaced matched filter of a plurality of symbol spaced matched filters included in said first filter stage and connected in parallel, the number of said plurality of symbol spaced matched filters being at least equal to the number of samples per symbol multiplied by the number of antennas;
summing the output signals of said plurality of symbol spaced matched filters so as to produce a single symbol spaced stream; and
inputting said single symbol spaced stream into the whitening filter of said second filter stage.

43. The method according to claim 42, wherein the whitening filtering is carried out as an all-poles filtering, in particular an all-poles infinitive impulse response filtering, in said second filter stage.

44. The method according to claim 43, wherein the all-poles filtering is carried out as an all-poles infinitive impulse response filtering.

45. The method according to claim 43, wherein the all-poles filtering is carried out as an all-zeros finite impulse response filtering.

46. The method according to claim 45, wherein the all-zeros finite impulse response filtering is carried out as a backward linear prediction.

47. A mobile unit, comprising:
a receiver configured to receive signals transmitted over a distorting channel;
a prefilter, comprised in the receiver, configured to convert an impulse response of the channel into its equivalent minimum phase; and
a distortion corrector, comprises in the receiver, provided downstream from said prefilter,
wherein said prefilter comprises
a first filter stage including a matched filter, and
a second filter stage provided downstream from said first filter stage and including a single whitening filter,
wherein said prefilter is configured to be a fractionally spaced filter,
wherein said prefilter further comprises a decomposer configured to decompose a fractionally spaced stream into a plurality of symbol spaced sub-streams, the number of said plurality of symbol spaced sub-streams being at least equal to the number of samples per symbol,
wherein said first filter stage includes a plurality of symbol spaced matched filters connected in parallel to the output of said decomposer, the number of said plurality of symbol spaced matched filters being at least equal to the number of symbol spaced sub-streams, and
wherein said prefilter further comprises an adder configured to sum the output signals of said plurality of symbol spaced matched filters so as to produce a single symbol spaced stream input into said whitening filter.

48. A mobile unit, comprising:
a receiver configured to receive signals transmitted over a distorting channel;
a prefilter, comprised in the receiver, configured to convert an impulse response of the channel into an equivalent minimum phase of the impulse response; and
a distortion corrector, comprised in the receiver, provided downstream from said prefilter,
wherein said prefilter comprises
a first filter stage including a matched filter, and
a second filter stage provided downstream from said first filter stage and including a single whitening filter,
wherein said prefilter is configured to be a fractionally spaced filter,
wherein the receiver further comprises a plurality of antennas and a multiplexer configured to multiplex oversampled streams arising from said plurality of antennas so as to form a single stream having an oversampling factor being at least equal to the number of samples per symbol multiplied by the number of antennas,
wherein said prefilter further comprises a decomposer configured to decompose a fractionally spaced stream into a plurality symbol spaced sub-streams, the number of said plurality of symbol spaced sub-streams being at least equal to the number of samples per symbol multiplied by the number of antennas,
wherein the input of said decomposer is coupled to the output of said multiplexer,
wherein said first filter stage includes a plurality of symbol spaced matched filters connected in parallel to the output of said decomposer, the number of said plurality of symbol spaced matched filters being at least equal to the number of samples per symbol multiplied by the number of antennas, and
wherein said prefilter further comprises an adder configured to sum the output signals of said plurality of symbol spaced matched filters so as to produce a single symbol spaced stream input into said whitening filter.

49. A receiver, comprising:
prefilter means for converting an impulse response of a channel into an equivalent minimum phase of the impulse response,
reception means for receiving signals transmitted over the channel, wherein the channel is a distorting channel; and
distortion corrector means for correcting distortion, wherein the distortion corrector means is provided downstream from said prefilter means,
wherein said prefilter means comprises first filter stage means for filtering including a matched filter and second filter stage means for filtering provided downstream from said first filter stage and including a single whitening filter,
wherein said prefilter means is configured to be a fractionally spaced filter,
wherein said prefilter means further comprises decomposer means for decomposing a fractionally spaced stream into a plurality of symbol spaced sub-streams, the number of said plurality of symbol spaced sub-streams being at least equal to the number of samples per symbol,
wherein said first filter stage means includes a plurality of symbol spaced matched filters connected in parallel to the output of said decomposer means, the number of said plurality of symbol spaced matched filters being at least equal to the number of symbol spaced sub-streams, and
wherein said prefilter means further comprises adder means for summing the output signals of said plurality of symbol spaced matched filters so as to produce a single symbol spaced stream input into said whitening filter.

50. A receiver, comprising:
prefilter means for converting an impulse response of a channel into an equivalent minimum phase of the impulse response,
reception means for receiving signals transmitted over the channel, wherein the channel is a distorting channel;
distortion corrector means for correcting distortion, wherein the distortion corrector means is provided downstream from said prefilter, wherein said prefilter means comprises first filter stage means for filtering including a matched filter and second filter stage means for filtering provided downstream from said first filter stage and including a single whitening filter, wherein said prefilter is configured to be a fractionally spaced filter;
a plurality of antenna means; and
multiplexer means for multiplexing oversampled streams arising from said plurality of antenna means so as to form a single stream having an oversampling factor that is at least equal to the number of samples per symbol multiplied by the number of antenna means,
wherein said prefilter means further comprises decomposer means for decomposing a fractionally spaced stream into a plurality symbol spaced sub-streams, the number of said plurality of symbol spaced sub-streams being at least equal to the number of samples per symbol multiplied by the number of antenna means,
wherein the input of said decomposer means is coupled to the output of said multiplexer means,
wherein said first filter stage means includes a plurality of symbol spaced matched filters connected in parallel to the output of said decomposer means, the number of said plurality of symbol spaced matched filters being at least equal to the number of samples per symbol multiplied by the number of antenna means, and
wherein said prefilter means further comprises adder means configured to sum the output signals of said plurality of symbol spaced matched filters so as to produce a single symbol spaced stream input into said whitening filter.

51. The receiver of claim 1, wherein the receiver is configured to be a digital receiver.

52. The receiver of claim 12, wherein the receiver is configured to be a digital receiver.

53. The prefilter of claim 23, wherein the pre-filter is configured to be used in a digital receiver.

54. The prefilter of claim 30, wherein the pre-filter is configured to be used in a digital receiver.

55. The method of claim 37, wherein the receiving the signals in the receiver comprises receiving the signals in a digital receiver.

56. The method of claim 42, wherein the receiving the signals in the receiver comprises receiving the signals in a digital receiver.

57. The mobile unit of claim 47, wherein the receiver is configured to be a digital receiver.

58. The mobile unit of claim 48, wherein the receiver is configured to be a digital receiver.

59. The receiver of claim 49, wherein the receiver is configured to be a digital receiver.

60. The receiver of claim 50, wherein the receiver is configured to be a digital receiver.
